(19) United States
(12) Patent Application Publication
(10) Pub. No.: US 2012/0069965 A1
(43) Pub. Date: Mar. 22, 2012

(54) METHOD FOR POSITIONING AN INSTRUMENT

(75) Inventors: Cornelius Scheffer, Stellenbosch (ZA); Jean-Pierre Conradie, Highveld (ZA); Amir David Zarrabi, Kanonberg (ZA); Kristiaan Schreve, Stellenbosch (ZA)

(73) Assignee: Stellenbosch University, Stellenbosch, Western Cape Province (ZA)

(21) Appl. No.: 13/203,625

(22) PCT Filed: Mar. 1, 2010
(86) PCT No.: PCT/IB2010/000410

§ 371 Date: Nov. 29, 2011

(30) Foreign Application Priority Data
Feb. 28, 2009 (ZA) 2008/07513

(51) Int. Cl. H05G 1/28

(52) U.S. Cl. 378/162

(57) ABSTRACT

A method of positioning a surgical instrument is provided which includes mapping a volume adjacent an operating table by taking mapping images from two orientations of a calibration object which includes a 3-dimensional array of radio opaque markers in a known configuration. A patient is positioned on the operating table with a patient target area within a mapped volume, and an instrument holder carrying a known configuration of radio opaque markers positioned adjacent the target area. Further fluoroscopic target images of the target area and instrument holder are obtained from the two orientations and the target area then reconstructed in 3-dimensions by comparing the target images to the mapping images. An instrument holder orientation is then calculated from the reconstruction.

### FIELD OF THE INVENTION

This invention relates to a method for positioning an instrument for insertion into a patient.

### BACKGROUND TO THE INVENTION

Percutaneous nephrolithotomy (PCNL), first described in 1976 by Fernstrom and Johansson, is a minimally invasive surgical procedure aimed at removing problematic kidney stones. Advances in surgical technique and technology over the past 30 years have allowed urologists to remove stones percutaneously with increasing efficiency. As the percutaneous route to stone removal is superior to the open approach in terms of morbidity, convalescence, and cost, PCNL has replaced open surgical removal of large or complex calculi at most institutions.

One of the steps in the PCNL procedure entails obtaining kidney calyx access to make the insertion of dilators and stone removal equipment possible. This access is usually obtained using one of two antegrade bi-planar fluoroscopy needle guidance techniques, namely “triangulation” and “eye of the needle” or “keyhole”. Both techniques consist of several specific steps where the fluoroscopy system (“C-arm”) is rotated into different positions relative to the needle and target, being the contrast filled calyx. The needle is advanced by the urologist until the calyx is punctured in a controlled and predictable fashion.

In “keyhole”, a urethral catheter is placed and the patient is positioned in the prone position. The C-arm fluoroscopy system is positioned at 30° and the access needle is positioned so the targeted calyx, needle tip and needle hub are in line with the image intensifier, giving a bull's-eye effect on the monitor. What the surgeon sees on the monitor is a view down the needle into the targeted calyx. Keeping this trajectory, the needle is advanced while continuous fluoroscopic monitoring is performed to ensure that the needle maintains the proper alignment. Needle depth is obtained by rotating the fluoroscopic system to a vertical orientation relative to the needle. When the needle is aligned with the targeted calyx, the urologist or radiologist should be able to aspirate urine from the collecting system, confirming proper needle positioning.

Unlike the “keyhole” technique, “triangulation” allows for needle alignment down the axis of the calyx. After the targeted calyx is identified, orientation of the line of puncture is performed using a triangulation technique which is implemented in the following manner: the C-arm is moved back and forth between two positions. One position is parallel to and the other oblique to the line of puncture. With the C-arm oriented parallel to the line of puncture, needle adjustments are made in the mediolateral direction. The C-arm is rotated to the oblique position and needle adjustments are made in the cranio/caudal orientation while keeping the mediolateral orientation of the needle unchanged. After the proper orientation of the line of puncture is obtained, the needle is advanced toward the desired calyx with the C-arm in the oblique position to gauge the depth of puncture.

Despite the fact that the details of these techniques are meticulously described, gaining correct access to a pre-identified area of a calyx is usually the most difficult part of PCNL. It often results in multiple needle punctures and repeated radiological screening which entails those present receiving prolonged doses of X-rays. For the patient this may not be too serious, but for those performing such procedures regularly this is undesirable. Also, “correct access” is not always obtained and urologists often end up accepting sub-optimal positions of access. The implications of this are increased duration of the procedure and decreased stone-free rates.

Several methods and techniques are found in the literature describing the positioning of an instrument, including a biopsy needle, during a medical procedure. Computed tomography (CT), ultrasound (US), magnetic resonance (MRI) or fluoroscopic imaging (FI) is used to plan and predict possible needle insertion paths. Some of these techniques, such as CT and MRI are overly expensive and can only be implemented in highly equipped facilities.

U.S. Pat. No. 6,249,713 describes an automated system in which a biopsy needle is aligned with a target using needle markers from two fluoroscopic images taken in orthogonal C-arm positions. Needle alignment angles are calculated by a computer system in a two step procedure where the first alignment angle is computed and set with the C-arm in position 1, and the second alignment angle is computed and set with the C-arm in position 2. Hereafter a needle holder is controlled by the system to insert the needle into the patient.

U.S. Pat. No. 6,097,994 describes an apparatus by which the insertion depth of a biopsy needle is determined. A pointing device exhibits first and second markers along its length such that respective images are formed on a first image plane by utilizing radiation from a radiation source, along with images corresponding to the selected point and the target area. The apparatus includes an arrangement for measuring distances on the image plane between the images and a calculator for calculating the cross ratio of the distances, whereby the proper insertion depth of the biopsy needle is determined.

U.S. Pat. No. 6,165,181 describes a system for defining the location of a medical instrument relative to features of a medical workspace including a patient's body region. Pairs of two-dimensional images obtained by two video cameras making images of the workspace along different sightlines which intersect are used. A calibration structure is used to define a three dimensional coordinate framework. Appropriate image pairs can then be used to locate and track any other feature such as a medical instrument in the workspace with the cameras fixed in their positions relative to the workspace. Computations are performed with a computer workstation.

U.S. Pat. No. 6,028,912 describes a method for point reconstruction and metric measurement on radiographic images using a fluoroscope. A positioning device on the patient's body at an arbitrarily selected point is visible in the radiographic image. Target points are specified by the operator on the radiographic image. The fluoroscope is rotated to a new position and a new radiographic image is taken, and points to be reconstructed are chosen.

U.S. Pat. No. 6,041,249 describes computed tomography apparatus equipped with a device marking a guide path on a patient for a medical instrument to be used in a medical procedure, such as a puncturing needle. The computed tomography apparatus produces a planning image, and a guide path is identified within the planning image. A computer, using the planning image and the path identified thereon, automatically adjusts a position of a light source, and if necessary a patient table on which a patient is supported, so that a beam from the light source is positioned to coincide with the guide path identified on the image.

The Robopsy™ system is a tele-operated, patient mounted, disposable needle guidance and insertion system to assist radiologists in performing minimally invasive percutaneous biopsies remotely under CT guidance.

PAKY™ (percutaneous access to the kidney) is a complete robotic percutaneous access system, which is a mechanical stereotactic frame and actuated needle system that can be used as a platform for needle placement using fluoroscopic imaging and point registration.

Many of the techniques described above are not utilized in practice due to high cost of the automated systems that are required and the need for specialized imaging equipment.

### OBJECT OF THE INVENTION

It is an object of this invention to provide a method for positioning an instrument for insertion into a patient which will at least partially alleviate some of the abovementioned problems.

### SUMMARY OF THE INVENTION

In accordance with this invention there is provided a method of positioning an instrument which includes
fluoroscopically mapping a volume adjacent an operating table by taking mapping images from two orientations of a calibration object which includes a 3-dimensional array of radio opaque markers in known configuration;
positioning a patient on the operating table with a patient target area within the mapped volume;
positioning adjacent the target area an instrument holder carrying a known configuration of radio opaque markers;
obtaining fluoroscopic target images of the target area and instrument holder from the two orientations;
reconstructing the target area in 3-dimensions by comparing the target images to the mapping images; and
calculating an instrument holder orientation from the reconstruction.

Further features of the invention provide for the calibration object to include three vertically spaced planar arrays of radio opaque markers configured such that each marker is fluoroscopically visible from each of the two orientations; for the planar arrays to extend parallel to each other; and for the operating table to include markings for locating the calibration object thereon.

Still further features provide for the instrument holder to be releasably securable to the operating table; and for the instrument holder to be manually adjustable.

Yet further features of the invention provide for an interface unit to be provided for communicating with a operator.

The invention also provides a system for positioning an instrument comprising a processor configured to

map a volume adjacent an operating table from a pair of fluoroscopic images of a calibration object taken from a pair of different orientations;

reconstruct a patient target area in three dimensions by comparing the images of the calibration object to a pair of images of the patient target area taken from the same orientations; and

to calculate an instrument orientation from the reconstruction based on at least one user selected target point.

### BRIEF DESCRIPTION OF THE DRAWINGS

The invention will be described, by way of example only, with reference to the drawings in which:

FIG. 1 is a schematic illustration of a volume mapping step;

FIG. 2 is a schematic illustration of a target imaging step;

FIG. 3 is a perspective view of a calibration object;

FIG. 4 is a fluoroscopic image of the calibration object in FIG. 3;

FIG. 5 is a perspective view of an instrument holder;

FIG. 6 is a perspective view of part of the instrument holder in FIG. 5; and

FIG. 7 is a top plan view of the part of the instrument holder in FIG. 6.

### DETAILED DESCRIPTION WITH REFERENCE TO THE DRAWINGS

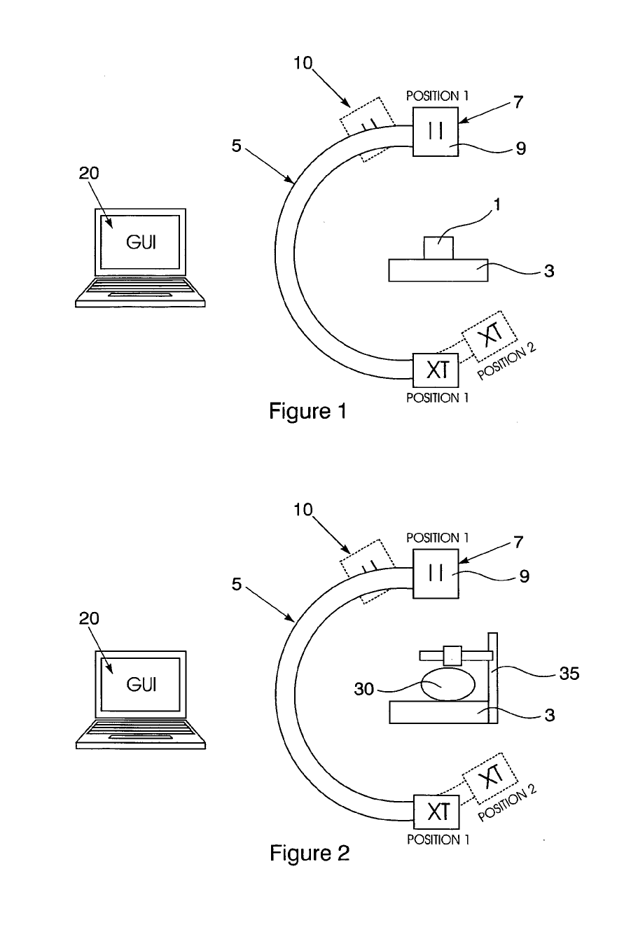

A method of positioning an instrument, in this embodiment a needle, is illustrated with reference to FIGS. 1 and 2. In a first step, illustrated in FIG. 1, a calibration object (1) is placed on an operating table (3) and a C-arm fluoroscope (5) used to take two images thereof. In this embodiment, the first image is taken from a first orientation (7) with the x-ray generator (9) directly overhead. The second image is taken from a second orientation (10) with the x-ray generator (shown in broken lines) rotated 20° from the first orientation.

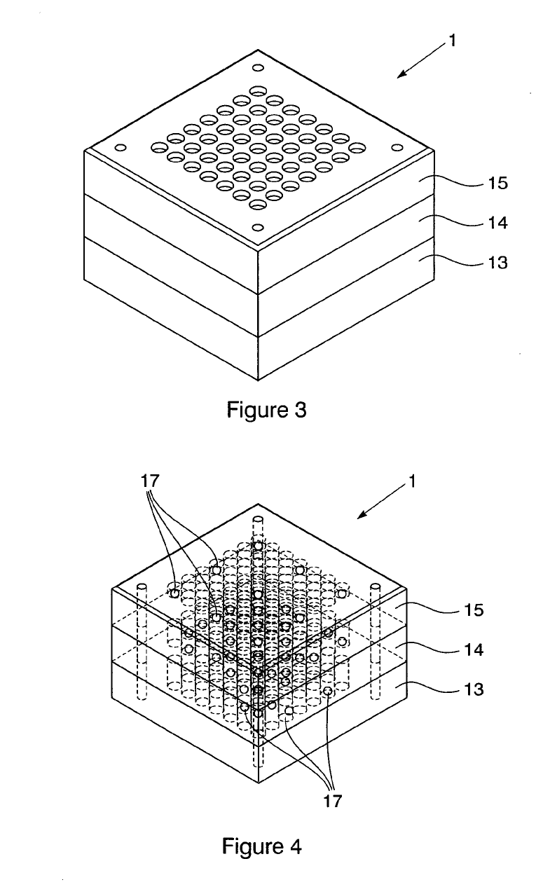

As shown in FIGS. 3 and 4, the calibration object (1) is box shaped and has three super adjacent layers (13, 14, 15), each of which has a plurality of radio opaque markers (17) arranged at a known location in a planar array. The markers (17) are furthermore arranged so that each is visible in the fluoroscopic images taken from both the first orientation and second orientation. The location of each marker (17) is pre-determined and in this embodiment each marker (17) is encapsulated in a radiolucent acrylic material.

Both images, hereafter referred to as the “mapping images”, are transferred to a processor (20), in this embodiment a computer, which is configured through software to map the volume occupied by the calibration object (1) in three dimensions. This is conveniently achieved using stereo vision theory which is well known in the art.

With the fluoroscope (5) calibrated in this manner, a patient (30) is positioned on the operating table (3) with the patient's target area, usually a specific internal organ, located within the space previously occupied by the calibration object, as shown in FIG. 2. Markings (not shown) on the operating table (3) are conveniently provided for positioning the calibration object (1) and subsequently the patient target area. Hereafter, an instrument holder (35) is secured to the operating table (3) and two fluoroscopic images once more taken from the first orientation (7) and second orientation (10) used in calibrating the fluoroscope (5). To assist in providing contrast, and where possible to do so, the internal organ may be filled with a suitable dye. These images, hereafter referred to as the “target images”, are also transferred to the computer (20) which reconstructs the target area of the patient (30) in three dimensions by comparing the target images to the mapping images.

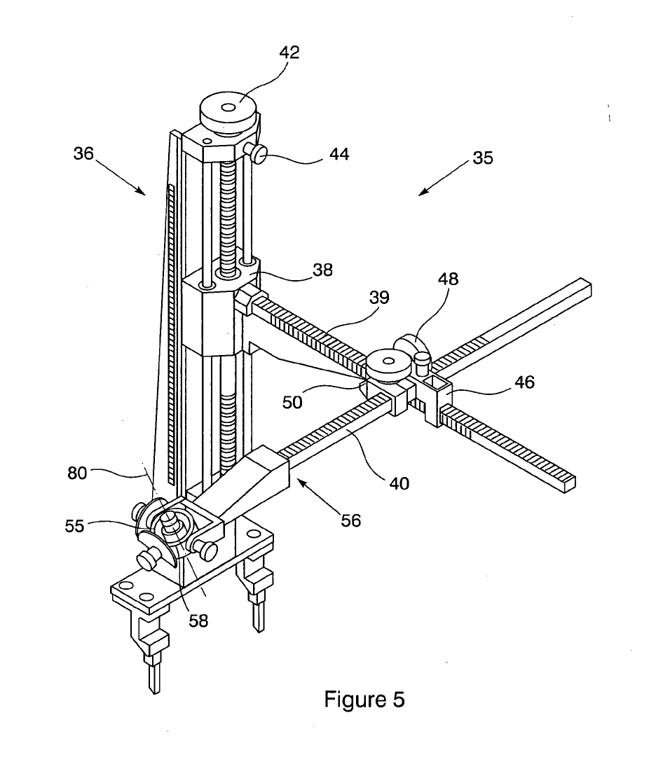

The instrument holder (35) is shown in FIG. 5 and includes an upright (36), providing a Z axis, with a carriage (38) movably secured thereto. A first arm (39) extends normally to the carriage (38) with a second arm (40) movably secured to it, these providing X and Y axes. The carriage (38) is movable along the upright (36) by a screw drive assembly operated by a knob (42). A locking knob (44) is provided for preventing rotation of the knob (42). A further carriage (46) secures the arm (40) to the arm (39) and is movable along the arm (39) by a knob (48) operated pinion (not shown) which co-operates with a rack (not shown) on the arm (39). Similarly, a knob (50) operated pinion (not shown) co-operates with a rack (not shown) on the arm (40) to permit translation in the Y axis.

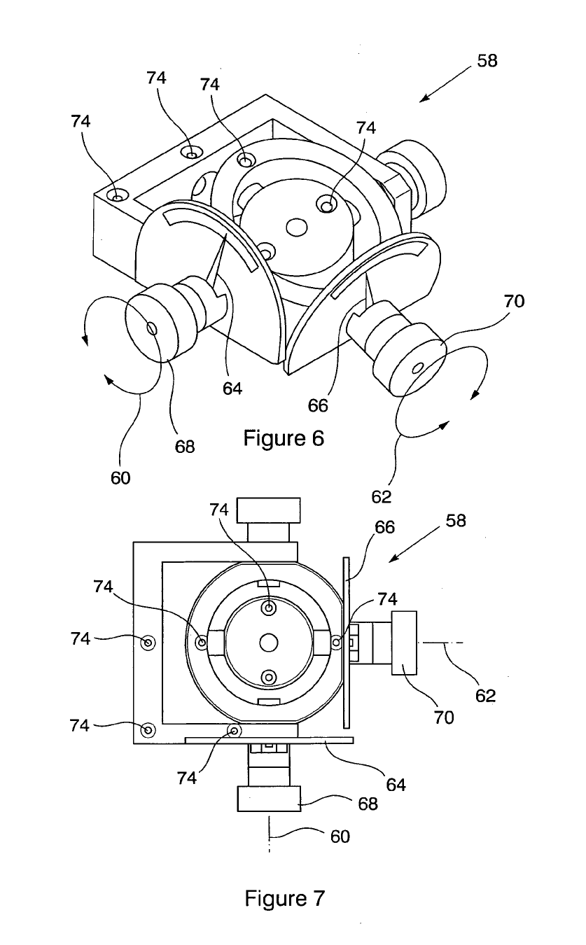

A needle holder (55) is carried at one end (56) of the arm (40) within a gyro mechanism (58) which is shown in more detail in FIGS. 6 and 7 and permits rotation about two axes (60, 62). Five degrees of freedom are thus permitted to the needle holder.

As also shown in FIGS. 6 and 7, dials (64, 66) are provided on each of the adjustment knobs (68, 70) of the gyro mechanism (58) so that the angular orientation of these may be measured.

Radio opaque markers (74) are provided on the gyro mechanism (58) at known locations.

With the needle holder (55) adjacent the target area of the patient (30), the markers (74) appear in the target images and after reconstructing the target images using the mapping images, the computer calculates an orientation for the instrument holder (55) for it to align with a specified point within the target area. Conveniently, this is achieved by presenting the reconstructed target area on a graphical user interface on the computer (20) and requesting the operator (not shown) to select either two or four points on the target area where needle insertion is desired. Hereafter, the computer calculates the required orientation for the needle holder to achieve insertion in the area and provides this as a relative position for each of the arms (39, 40) and each of the axes (60, 62) of the gyro mechanism. The operator, subsequently manually adjusts the instrument holder (35) and this is particularly facilitated by the dials (64, 66). Once the needle holder (55) is correctly oriented, a needle (80) is inserted therein and advanced into the patient (30) to the desired depth, which can also be calculated by the computer (20). The arms (39, 40) and gyro mechanism (58) are locked in position and the needle inserted. The depth of needle penetration is determined by monitoring relative translation from the needle starting point. Hereafter, the procedure may be carried out in normal fashion.

The method of the invention is easy to implement, requires minimal exposure to radiation by operating room staff and patients and provides surgeons with manual control over the orientation and insertion of the needle or instrument. Mapping the volume to be occupied by the patient target area in three dimensions using the calibration object provides an accurate basis for later calculating instrument orientation without operating room staff or patients having to be exposed to radiation. It also obviates the need for complex calibration of automated instrument holders which are in a dedicated association with the fluoroscope. Furthermore, as the patient target area is reconstructed in three dimensions using the mapped three dimensional volume, it is unnecessary to continually take fluoroscopic images of the patient during the procedure to make adjustments and monitor progress.

Importantly, the method of the invention permits the instrument holder to be separate from the fluoroscope. This permits the fluoroscope to be used for other applications and also permits different instrument holders to be used for different procedures.

Even though a certain amount of “lens distortion” can occur during imaging, it has been found that it is not necessary to compensate for this, particularly where the patient is centrally located in the target area. If it is desired to compensate for distortions, this can be accomplished quite simply through appropriate software.

It will be appreciated, that many other embodiments of a method exist which fall within the scope of the invention, particularly regarding the configuration of the calibration object and of the software and user interface. It will be appreciated that it may only be necessary to calibrate the fluoroscope once for a number of procedures where it is fixed relative to the operating table as the targeting images for each patient can simply be compared to a single set of mapping images. Provided that the patient target area and instrument holder are within the previously calibrated space it is necessary only to take images of the patient and instrument holder as described.

Also, any suitable instrument holder can be used and this could be provided with means for controlling it through the processor. The method could also be extended to any suitable procedure, whether on humans or animals, and it need not only be used for PCNL.

More than two images can be taken, each from a different orientation, to enhance accuracy if desired.

1. A method of positioning an instrument comprising:
fluoroscopically mapping a volume adjacent an operating table by taking mapping images from two orientations of a calibration object which includes a 3-dimensional array of radio opaque markers in known configuration;
positioning a patient on the operating table with a patient target area within the mapped volume;
positioning adjacent the target area an instrument holder carrying a known configuration of radio opaque markers;
obtaining fluoroscopic target images of the target area and instrument holder from the two orientations;
reconstructing the target area in 3-dimensions by comparing the target images to the mapping images; and
calculating an instrument holder orientation from the reconstruction.

2. A method as claimed in claim 1 wherein the calibration object includes three vertically spaced planar arrays of radio opaque markers, configured such that each marker is fluoroscopically visible from each of the two orientations.

3. A method as claimed in claim 2 wherein the planar arrays extend parallel to each other.

4. A method as claimed in any of the preceding claim 1 wherein the operating table includes markings for locating the calibration object thereon.

5. A method as claimed in claim 1 wherein the instrument holder is manually adjustable.

6. A method as claimed in claim 1 which further comprises an interface unit that communicates with an operator.

7. A system for positioning an instrument comprising a processor configured to map a volume adjacent an operating table from a pair of fluoroscopic images of a calibration object taken from a pair of different orientations, and wherein the processor reconstructs a patient target area in three dimensions by comparing the images of the calibration object to a pair of images of the patient target area taken from the same orientations, and wherein the processor calculates an instrument orientation from the reconstruction based on at least one user selected target point.

8. A system as claimed in claim 7 wherein the images of the patient target area include images of an instrument holder carrying a known configuration of radio opaque markers.

9. A system as claimed in claim 7 wherein the calibration object includes a 3-dimenisonal array of radio opaque markers in known configuration.

10. A system as claimed in claim S wherein the calibration object includes a 3-dimenisonal array of radio opaque markers in known configuration.
